(19) United States
(12) Patent Application Publication
(10) Pub. No.: US 2006/0028405 A1
(43) Pub. Date: Feb. 9, 2006

(54) Plasma display apparatus and driving method thereof

(75) Inventor: Seong Hak Moon, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/190,063

(22) Filed: Jul. 27, 2005

(30) Foreign Application Priority Data
Jul. 27, 2004 (KR) 2004-00/58926

(51) Int. Cl. G09G 3/28

(52) U.S. Cl. 345/60

(57) ABSTRACT

The present invention discloses a plasma display apparatus and a driving method thereof. The plasma display apparatus includes a plasma display panel having scan electrodes and sustain electrodes connected to a reference potential node, and an electrode integration driving unit for alternately applying a first voltage and a second voltage to the scan electrodes in a sustain period. The present invention can restrict noises and interferences, minimize heat generation and luminance differences, and reduce detrimental effects of a displacement current by the sustain electrodes connected to the reference potential node, the electrode integration driving unit and a switching control unit.

This Nonprovisional application claims priority under 35 U.S.C. § 119(a) on Patent Application No. 2004-0058926 filed in Korea on 27 Jul., 2004, the entire contents of which are hereby incorporated by reference.

### BACKGROUND OF THE INVENTION

1. Field of the Invention

The present invention relates to a plasma display apparatus, and more particularly, to a plasma display apparatus and a driving method thereof.

2. Description of the Related Art

FIG. 1 illustrates one example of a rear surface structure of a conventional plasma display apparatus. Referring to FIG. 1, the conventional plasma display apparatus includes a scan electrode driving board 45, a sustainer electrode driving board 48, a data driver board 50, a control board 42 and a power source board (not shown).

The scan electrode driving board 45 drives scan electrodes of a plasma display panel 40. The sustain electrode driving board 48 drives sustain electrodes. The data driver board 50 drives data electrodes. The control board 42 controls the scan electrode driving board 45, the sustain electrode driving board 48 and the data driver board 50. The power source board (not shown) supplies power to the boards 42, 45, 48 and 50, respectively.

The scan electrode driving board 45 includes a scan driver board 44 and an Y sustainer board 46. The scan driver board 44 generates reset pulses and scan pulses, and applies the pulses to the scan electrodes. The Y sustainer board 46 generates Y sustain pulses and applies the pulses to the scan electrodes.

The scan driver board 44 applies the scan pulses to the scan electrodes of the plasma display panel 40 in an addressing period via an Y flexible printed circuit 51 (hereinafter, referred to as ‘FPC’). The Y sustainer board 46 applies the Y sustain pulses to the scan electrodes in a sustain period via the scan driver board 44 and the Y FPC 51.

The sustain electrode driving board 48 generates bias pulses in the addressing period, applies the pulses to the sustain electrodes, generates Z sustain pulses in the sustain period, and applies the pulses to the sustain electrodes of the plasma display panel 40 via a Z FPC 52.

The data driver board 50 generates data pulses in the addressing period, and applies the pulses to the data electrodes of the plasma display panel 40 via an X FPC 54.

The control board 42 generates an X timing control signal, an Y timing control signal and a Z timing control signal for controlling the data driver board 50, the scan electrode driving board 45 and the sustain electrode driving board 48, respectively. The control board 42 transmits the Y timing control signal to the scan electrode driving board 45 via a first FPC 56. The control board 42 transmits the Z timing control signal to the sustain electrode driving board 48 via a second FPC 58. The control board 42 transmits the X timing control signal to the data driver board 50 via a third FPC 60.

As described above, the conventional plasma display apparatus of FIG. 1 is weak to electromagnetic interferences because the high voltage radio frequency driving pulses are applied to the scan electrodes, the sustain electrodes and the data electrodes.

FIG. 2 illustrates another example of the rear surface structure of the conventional plasma display apparatus. As illustrated in FIG. 2, the conventional plasma display apparatus includes a plasma display panel 70, a heat sink 86 installed on the rear surface of the plasma display panel 70, an Y-Z integration board 71 installed on the rear surface of the heat sink 86, a data driver board 80, a control board 72, and a power source board (not shown) for supplying power to the boards 71, 72 and 80, respectively.

The plasma display panel 70 is formed by bonding a top plate 90 and a bottom plate 92 with a gas discharge space. Here, scan electrodes and sustain electrodes are formed on the top plate 90 side by side, and data electrodes are formed on the bottom plate 92.

In addition, an Y pad region 94 is disposed at one side portion of the top plate 90 and Y pads (not shown) connected to the scan electrodes are formed therein, and a Z pad region 96 is disposed at the other side portion of the top plate 90 and Z pads (not shown) connected to the sustain electrodes are formed therein.

An X pad region (not shown) is disposed at one side portion of the bottom plate 92 and X pads (not shown) connected to the data electrodes are formed therein. The top plate 90 and the bottom plate 92 are bonded to each other, exposing the Y pad region 94, the Z pad region 96 and the X pad region (not shown).

The heat sink 86 contacts the bottom plate 92 of the plasma display panel 70 and externally emits heat generated in the plasma display panel 70. Here, a through hole 85 for a Z FPC 84 is formed on the heat sink 86. The Z FPC 84 electrically connects an Y-Z sustainer board 74 to the Z pad region 96 formed on the top plate 90.

The control board 72 generates an X timing control signal, a first Y timing control signal, a second Y timing control signal and a Z timing control signal, respectively. The control board 72 transmits the Y timing control signal and the Z timing control signal to the Y-Z sustainer board 74 via a first FPC 76. In addition, the control board 72 transmits the X timing control signal to the data driver board 80 via a second FPC 78.

The data driver board 80 generates data pulses according to the X timing control signal from the control board 72, and supplies the data pulses to the data electrodes of the plasma display panel 70 via an X FPC 88. Here, the X FPC 88 connects the data driver board 80 to the X pad region (not shown).

The Y-Z integration board 71 includes a scan driver board 73, an Y-Z sustainer board 74, and a connector 75 for connecting the two boards 73 and 74.

According to the first Y timing control signal from the control board 72, the scan driver board 73 generates reset pulses applied to the scan electrodes in a reset period and also generates scan pulses applied to the scan electrodes in an addressing period. The scan driver board 73 applies the reset and scan pulses to the scan electrodes of the plasma display panel 70 via an Y FPC 82. The Y FPC 82 is connected to the scan driver board 73 and the Y pad region 94 of the plasma display panel 70.

A Y sustain circuit and a Z sustain circuit are embodied on the Y-Z sustainer board 74. The Y sustain circuit generates sustain pulses applied to the scan electrodes. The Z sustain circuit generates bias pulses and sustain pulses applied to the sustain electrodes. The Y-Z sustainer board 74 alternately generates sustain pulses applied to the scan electrodes and the sustain electrodes in the sustain period according to the second Y timing control signal and the Z timing control signal from the control board 72. Moreover, the Y-Z sustainer board 74 generates bias pulses applied to the sustain electrodes in the reset period and the addressing period.

However, the conventional plasma display apparatus of FIG. 2 is weak to electromagnetic interferences because the high voltage radio frequency driving pulses are applied to the scan electrodes, the sustain electrodes and the data electrodes.

In addition, the Y-Z integration board 71 is formed on one board by moving the sustain electrode driving board 48 formed at the right side to the left side and integrating the sustain electrode driving board 48 and the scan electrode driving board 45. Accordingly, a relatively large number of circuits are disposed at the left side of the plasma display apparatus. As a result, interferences or noises increase between the driving circuits disposed at the left side, and heats increase on a PCB of the Y-Z integration board 71 due to a high current.

The Y-Z integration board 71 must be connected to the Z pad region 96 formed at the right side and connected to the sustain electrodes through a conductive wire or conductive material. Therefore, luminance differences are caused to the right and left sides of the screen due to voltage drop by impedance effects of the conductive wire or conductive material.

On the other hand, the data driver boards 50 and 80 of the conventional plasma display apparatus of FIGS. 1 and 2 are very weak to a displacement current.

FIG. 3 is a circuit diagram for explaining the displacement current generated in the conventional plasma display apparatus. As shown in FIG. 3, in a scan process, when a channel corresponding to a first scan electrode Y1 is selected, channels corresponding to the other scan electrodes Y2, Y3, . . . , Yn are not selected.

When the channel is selected, a second switching element 213-1 of a first scan driver 210-1 corresponding to the selected channel is turned on, and a scan switching element 220 is turned on.

At the same time, first switching elements 211-2 to 211-n of scan drivers 210-2 to 210-n corresponding to the non-selected channels and a ground switching element 230 are turned on.

In addition, when a data voltage+V or 0V is applied to data electrodes X1 to Xm by operations of first data switching elements 310-1 to 310-m or second data switching elements 320-1 to 320-m of data driver ICs 300-1 to 300-m formed on the data driver boards 50 and 80, the write operation is performed on a cell positioned on the first scan electrode Y1.

When the above process is performed on all the scan electrodes, the scan process is finished. After the scan process, a first sustain switching element 240, second switching elements 213-1, 213-2, 213-3, . . . , 213-n of the scan drivers 210-1, 210-2, 210-3, . . . , 210-n, and a ground switching element 260 are turned on.

Accordingly, a loop is formed by the first sustain switching element 240, the second switching elements 213-1, 213-2, 213-3, . . . , 213-n of the scan drivers 210-1, 210-2, 210-3, . . . , 210-n, the scan electrodes Y1, Y2, Y3, . . . , Yn, the sustain electrodes Z1, Z2, Z3, . . . Zn, and the ground switching element 260, and thus a first sustain voltage+Vsy is applied to the scan electrodes Y1, Y2, Y3, . . . , Yn.

Thereafter, a second sustain switching element 250, first switching elements 211-1, 211-2, 211-3, . . . , 211-n of the scan drivers 210-1, 210-2, 210-3, . . . , 210-n, and the ground switching element 230 are turned on.

Therefore, a loop is formed by the sustain electrodes Z1, Z2, Z3, . . . Zn, the scan electrodes Y1, Y2, Y3, . . . , Yn, the first switching elements 211-1, 211-2, 211-3, . . . , 213-n of the scan drivers 210-1, 210-2, 210-3, . . . , 210-n, and the ground switching element 230, and thus a second sustain voltage+Vsz is applied to the sustain electrodes Z1, Z2, Z3, . . . Zn, respectively.

The general plasma display panel has a three-electrode structure. Still referring to FIG. 3, a first equivalent capacitor Cm1 exists between the adjacent data electrodes, and a second equivalent capacitor Cm2 exists between the data electrode and the scan electrode or between the data electrode and the sustain electrode.

In a sustain process, when the sustain pulses are alternately applied to the scan electrodes Y1 to Yn and the sustain electrodes Z1 to Zn, potential states of the scan electrodes Y1 to Yn and the sustain electrodes Z1 to Zn are changed. Thus, a displacement current Id is generated by the first equivalent capacitor Cm1 and the second equivalent capacitor Cm2.

The displacement current Id flows into the data driver ICs 300-1 to 300-m through the data electrodes X1 to Xm, thereby destroying the data driver ICs 300-1 to 300-m or causing noises.

### SUMMARY OF THE INVENTION

Accordingly, it is a primary object of the present invention to provide a plasma display apparatus and a driving method thereof which can minimize electromagnetic interferences.

Another object of the present invention is to provide a plasma display apparatus and a driving method thereof which can minimize noises.

Still another object of the present invention is to provide a plasma display apparatus and a driving method thereof which can minimize heat generation on a PCB.

Still another object of the present invention is to provide a plasma display apparatus and a driving method thereof which can minimize luminance differences at right and left sides of a screen caused by impedance effects of a conductive wire or conductive material.

Still another object of the present invention is to provide a plasma display apparatus and a driving method thereof which can minimize detrimental effects of a displacement current.

In order to achieve the above-described objects of the present invention, there is provided a plasma display apparatus, including: a plasma display panel having scan electrodes and sustain electrodes connected to a reference potential node; and an electrode integration driving unit for alternately applying a first voltage and a second voltage to the scan electrodes in a sustain period.

In addition, there is provided a plasma display apparatus, including: a plasma display panel having scan electrodes and sustain electrodes connected to a reference potential; an electrode integration driving unit for alternately applying a first positive voltage and a second negative voltage to the scan electrodes in a sustain period; and a switching control unit for floating data electrodes in the sustain period.

There is also provided a driving method of a plasma display apparatus, including the steps of: applying a first voltage to scan electrodes in a sustain period; and alternately applying the first voltage and a second voltage to the scan electrodes in the sustain period.

The present invention can minimize noises and interferences by the sustain electrodes connected to the reference potential node and the electrode integration driving unit.

The present invention can minimize heat generation by the sustain electrodes connected to the reference potential node and the electrode integration driving unit.

The present invention can restrict generation of luminance differences by the sustain electrodes connected to the reference potential node and the electrode integration driving unit.

The present invention can prevent a displacement current from flowing into a data electrode driving unit in the sustain process by the sustain electrodes connected to the reference potential node, the electrode integration driving unit and the switching control unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates one example of a rear surface structure of a conventional plasma display apparatus;

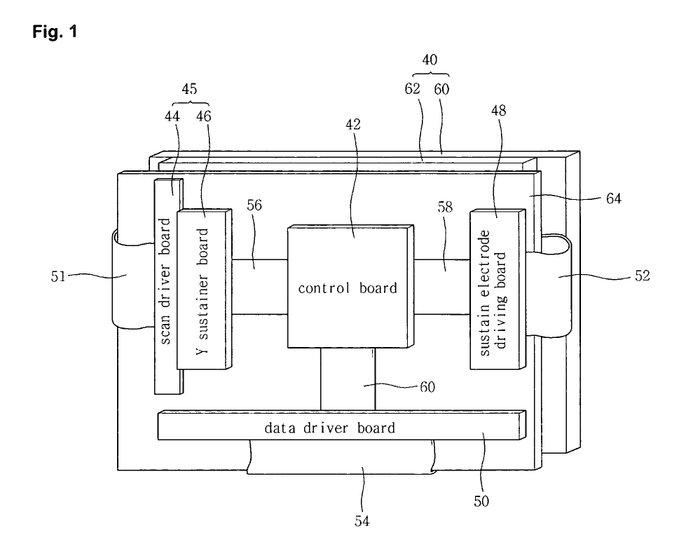

FIG. 2 illustrates another example of the rear surface structure of the conventional plasma display apparatus;

FIG. 3 is a circuit diagram for explaining a displacement current generated in the conventional plasma display apparatus;

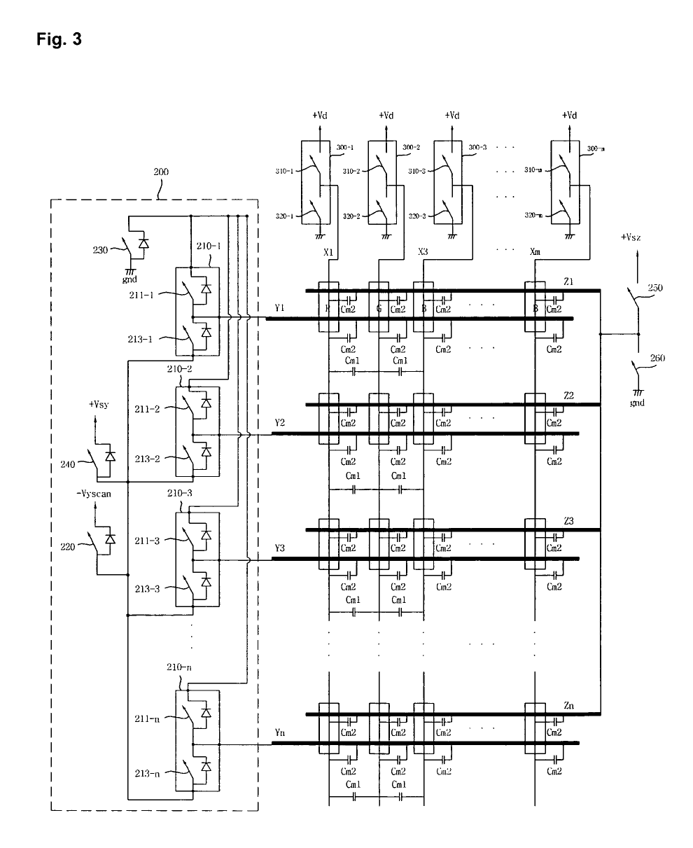

FIG. 4 illustrates a plasma display apparatus in accordance with a first embodiment of the present invention;

FIG. 5 is a circuit diagram illustrating the plasma display apparatus in accordance with the first embodiment of the present invention;

FIG. 6a illustrates a first operation of the plasma display apparatus in accordance with the first embodiment of the present invention;

FIG. 6b illustrates a second operation of a driving device of a plasma display panel in accordance with the first embodiment of the present invention;

FIG. 7 is a switching timing diagram for the operation of the first embodiment of the present invention;

FIG. 8 illustrates a plasma display apparatus in accordance with a second embodiment of the present invention;

FIG. 9 is a circuit diagram illustrating the plasma display apparatus in accordance with the second embodiment of the present invention;

FIG. 10a illustrates a first operation of the plasma display apparatus in accordance with the second embodiment of the present invention;

FIG. 10b illustrates a second operation of a driving device of a plasma display panel in accordance with the second embodiment of the present invention; and

FIG. 11 is a switching timing diagram for the operation of the second embodiment of the present invention.

### DETAILED DESCRIPTION OF THE PREFERRED EMBODIMENT

A plasma display apparatus and a driving method thereof in accordance with preferred embodiments of the present invention will now be described in detail with reference to the accompanying drawings.

According to one aspect of the present invention, a plasma display apparatus includes a plasma display panel having scan electrodes and sustain electrodes connected to a reference potential node, and an electrode integration driving unit for alternately applying a first voltage and a second voltage to the scan electrodes in a sustain period.

The sustain electrodes are connected to the ground.

The electrode integration driving unit alternately applies a first positive voltage and a second negative voltage to the scan electrodes.

The electrode integration driving unit alternately applies the first positive voltage and the second negative voltage to the scan electrodes in the same size.

The plasma display apparatus further includes a switching control unit for floating data electrodes in the sustain period.

The electrode integration driving unit includes a floating switch for applying signals corresponding to image data to the data electrodes in an addressing process, and floating the data electrodes in the sustain process.

The electrode integration driving unit includes scan drivers connected to the scan electrodes, for applying the first voltage or the second voltage to the scan electrodes, a scan switch turned on in the addressing process, for applying a scan voltage to the scan electrode connected to the selected scan driver, a first voltage applying unit having a first driving switch for applying the first voltage to the scan electrodes through the scan drivers, and a second driving switch for applying the voltage of the reference potential node to the scan electrodes connected to the scan drivers, and a second voltage applying unit having a third driving switch for applying the second voltage to the scan electrodes connected to the scan drivers, and a fourth driving switch for applying the voltage of the reference potential node to the scan electrodes connected to the scan drivers.

The first voltage applying unit includes the first driving switch for applying the first voltage to the scan electrodes through the scan drivers, and the second driving switch for applying the ground level voltage to the scan electrodes connected to the scan drivers. The second voltage applying unit includes the third driving switch for applying the second voltage to the scan electrodes through the scan drivers, and the fourth driving switch for applying the ground level voltage to the scan electrodes connected to the scan drivers.

According to another aspect of the present invention, a plasma display apparatus includes a plasma display panel having scan electrodes and sustain electrodes connected to a reference potential, an electrode integration driving unit for alternately applying a first positive voltage and a second negative voltage to the scan electrodes in a sustain period, and a switching control unit for floating data electrodes in the sustain period.

The sustain electrodes are connected to the ground.

The electrode integration driving unit alternately applies a first positive voltage and a second negative voltage to the scan electrodes.

The electrode integration driving unit alternately applies the first positive voltage and the second negative voltage to the scan electrodes in the same size.

The electrode integration driving unit includes a floating switch for applying signals corresponding to image data to the data electrodes in an addressing process, and floating the data electrodes in a sustain process.

The electrode integration driving unit includes scan drivers connected to the scan electrodes, for applying the first voltage or the second voltage to the scan electrodes, a scan switch turned on in the addressing process, for applying a scan voltage to the scan electrode connected to the selected scan driver, a first voltage applying unit having a first driving switch for applying the first voltage to the scan electrodes through the scan drivers, and a second driving switch for applying the voltage of the reference potential to the scan electrodes connected to the scan drivers, and a second voltage applying unit having a third driving switch for applying the second voltage to the scan electrodes connected to the scan drivers, and a fourth driving switch for applying the voltage of the reference potential to the scan electrodes connected to the scan drivers.

The first voltage applying unit includes the first driving switch for applying the first voltage to the scan electrodes through the scan drivers, and the second driving switch for applying the ground level voltage to the scan electrodes connected to the scan drivers. The second voltage applying unit includes the third driving switch for applying the second voltage to the scan electrodes through the scan drivers, and the fourth driving switch for applying the ground level voltage to the scan electrodes connected to the scan drivers.

According to still another aspect of the present invention, a driving method of a plasma display apparatus includes the steps of applying a first voltage to scan electrodes in a sustain period, and alternately applying the first voltage and a second voltage to the scan electrodes in the sustain period.

The sustain electrodes are connected to the ground.

The first voltage is a first positive voltage and the second voltage is a second negative voltage.

The first positive voltage is identical in size to the second negative voltage.

In the process for alternately applying the first voltage and the second voltage to the scan electrodes, data electrodes are floated.

The preferred embodiments of the present invention will now be described in detail with reference to the accompanying drawings.

### EMBODIMENT 1

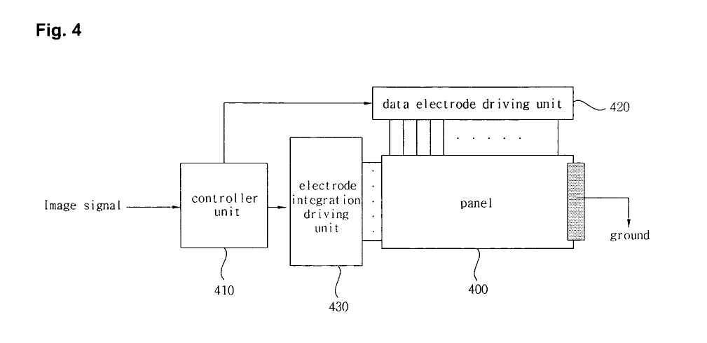

FIG. 4 illustrates a plasma display apparatus in accordance with a first embodiment of the present invention. Referring to FIG. 4, a driving device of a plasma display panel includes a plasma display panel 400, a controller unit 410, a data electrode driving unit 420 and an electrode integration driving unit 430.

<Plasma Display Panel>

The plasma display panel 400 displays images on discharge gases between a top plate and a bottom plate by applying a driving voltage to scan electrodes, sustain electrodes connected to a reference potential node, and data electrodes. Preferably, the reference potential node connected to the sustain electrodes is the ground.

<Controller Unit>

The controller unit 410 receives image signals and controls driving timing of the data electrodes and the scan electrodes.

<Data Electrode Driving Unit>

The data electrode driving unit 420 applies a data voltage for displaying images to the data electrodes under the control of the controller unit 410.

<Electrode Integration Driving Unit>

Under the control of the controller unit 410, the electrode integration driving unit 430 applies a scan voltage for addressing to the scan electrodes, and alternately applies a first voltage and a second voltage for maintaining electric discharge to the scan electrodes. Preferably, the electrode integration driving unit 430 applies a first positive voltage and a second negative voltage to the scan electrodes. More preferably, the electrode integration driving unit 430 alternately applies the positive sustain voltage and the negative sustain voltage to the scan electrodes in the same size.

As described above, the electrode integration driving unit 430 alternately applies the first positive voltage and the second negative voltage to the scan electrodes in order to maintain electric discharge. Therefore, a potential difference between the scan electrodes and the sustain electrodes connected to the reference potential node becomes a voltage for maintaining electric discharge, thereby maintaining electric discharge.

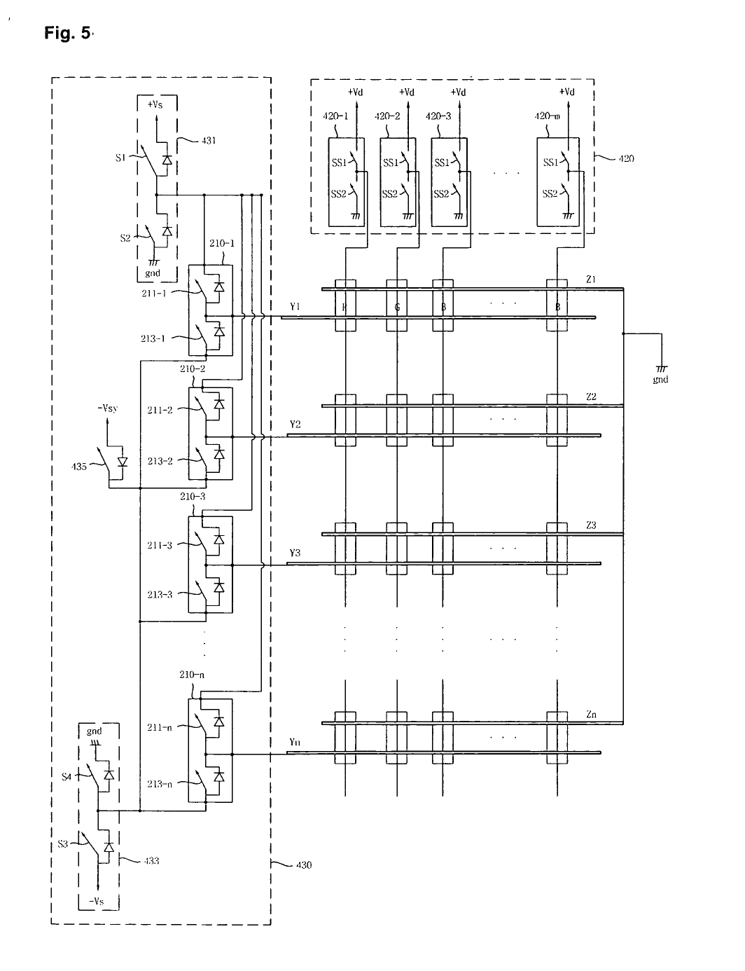

FIG. 5 is a circuit diagram illustrating the plasma display apparatus in accordance with the first embodiment of the present invention. As illustrated in FIG. 5, the plasma display apparatus includes a data electrode driving unit 420 for driving data electrodes, and an electrode integration driving unit 430 having scan drivers 210-1 to 210-n, a first voltage applying unit 431, a second voltage applying unit 433, and a scan switch 435. Here, sustain electrodes Z1, Z2, . . . , Zn are connected directly to the ground level reference potential node.

The data electrode driving unit 420 applies a data voltage for selecting a cell that will be displayed in an addressing process to data electrodes X1, X2, . . . , Xm. For this, the data electrode driving unit 420 includes data drivers 420-1, 420-2, . . . , 420-m. Each of the data drivers 420-2, . . . , 420-m has a first status switch SS1 and a second status switch SS2 for applying a high level or low level to the data electrodes X1, X2, . . . , Xm.

The scan drivers 210 to 210-n are connected respectively to the scan electrodes Y1, Y2, . . . , Yn. Under the control of the controller unit 410, the scan drivers 210 to 210-n apply a scan voltage−Vsy for addressing to the scan electrodes Y1, Y2, . . . , Yn, and alternately apply a positive sustain voltage+Vs that is a first voltage and a negative sustain voltage−Vs that is a second voltage to the scan electrodes Y1, Y2, . . . , Yn to maintain electric discharge.

When the data voltage is applied to the data electrodes X1, X2, . . . , Xm through the data drivers 420-1, 420-2, . . . , 420-m, the scan switch 435 is turned on in the addressing process by the timing signal from the controller unit 410, for applying the scan voltage−Vsy to the scan electrode connected to the selected scan driver (one of the scan drivers 210-1 to 210-n).

The first voltage applying unit 431 applies the positive sustain voltage+Vs that is the first voltage to the scan electrodes Y1, Y2, . . . , Yn connected to the scan drivers 210-1, 210-2, . . . , 210-n by a first driving switch S1 turned on under the control of the controller unit 410, and also applies the ground level voltage that is the voltage of the reference potential node to the scan electrodes Y1, Y2, . . . , Yn through the scan drivers 210-1, 210-2, . . . , 210-n by a second driving switch S2 turned on under the control of the controller unit 410.

The second voltage applying unit 433 applies the negative sustain voltage−Vs that is the second voltage to the scan electrodes Y1, Y2, . . . , Yn connected to the scan drivers 210-1, 210-2, . . . , 210-n by a third driving switch S3 turned on under the control of the controller unit 410, and also applies the ground level voltage that is the voltage of the reference potential node to the scan electrodes Y1, Y2, . . . , Yn through the scan drivers 210-1, 210-2, . . . , 210-n by a fourth driving switch S4 turned on under the control of the controller unit 410.

The operation of the first embodiment of the present invention will now be explained with reference to the accompanying drawings.

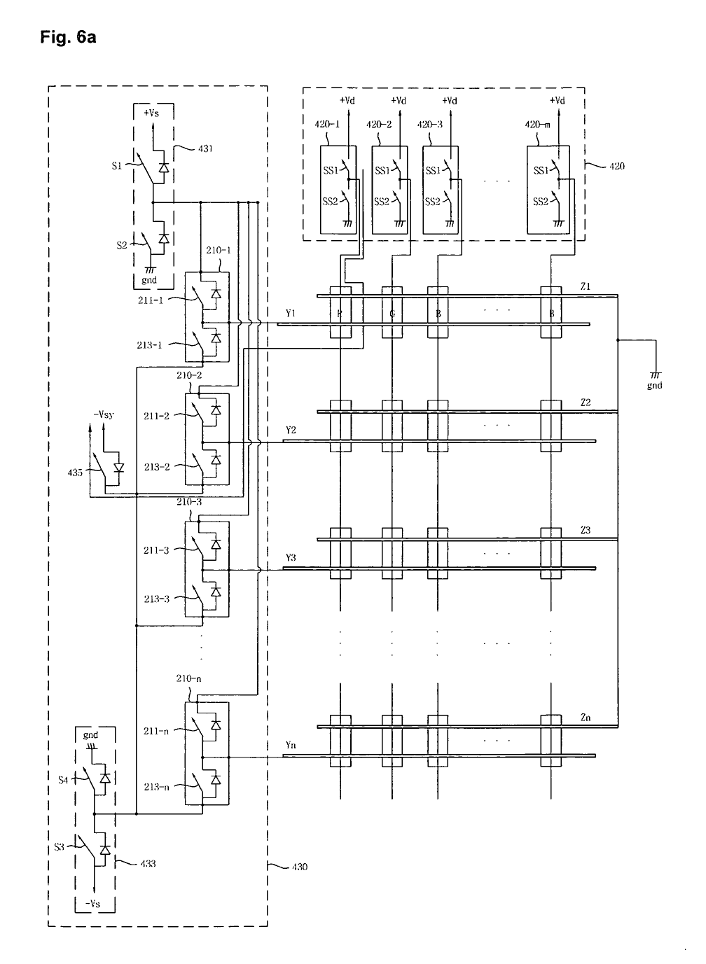

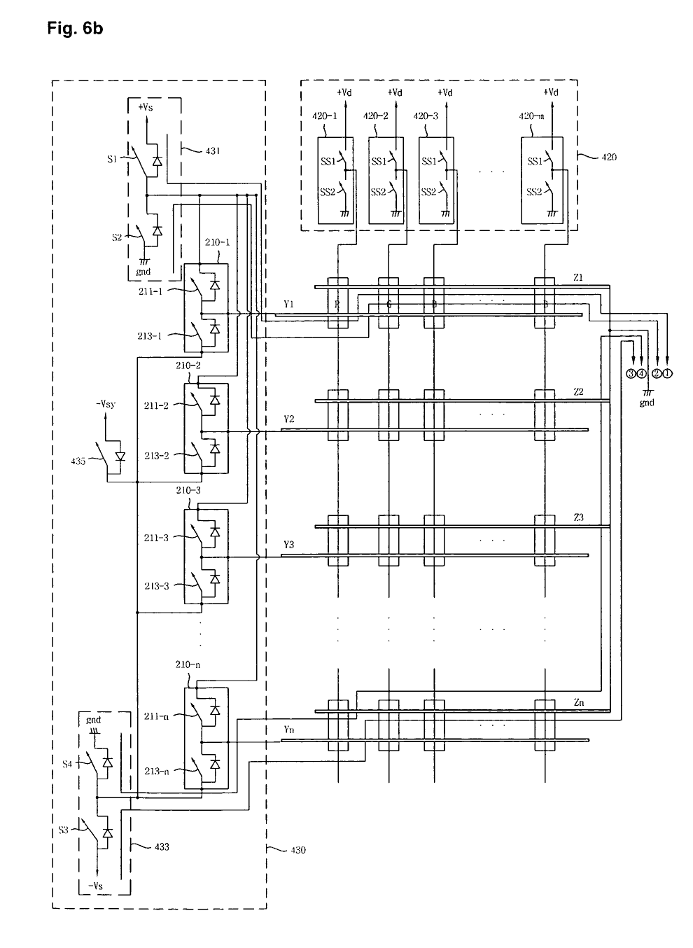

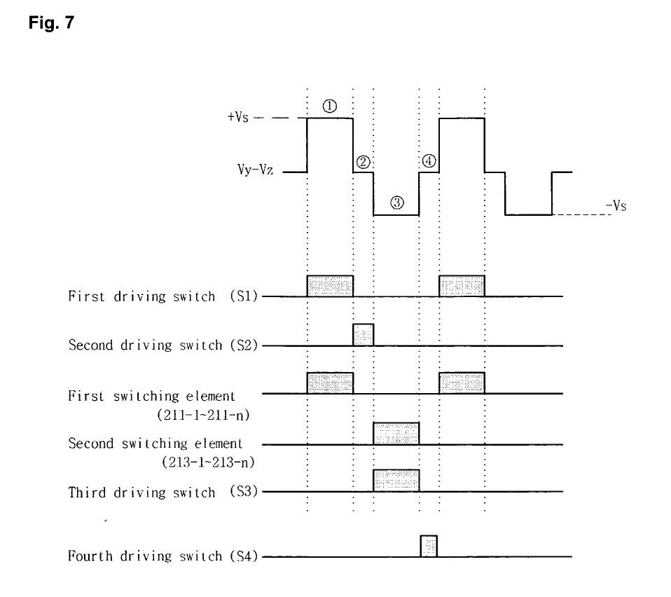

FIG. 6a illustrates a first operation of the plasma display apparatus in accordance with the first embodiment of the present invention. FIG. 6b illustrates a second operation of the driving device of the plasma display panel in accordance with the first embodiment of the present invention. FIG. 7 is a switching timing diagram for the operation of the first embodiment of the present invention.

As depicted in FIG. 6a, one of the first status switch SS1 and the second status switch SS2 of the data electrode driving unit 420, a second switching element (one of switching elements 213-1 to 213-n) of the selected scan driver (one of the scan drivers 210-1 to 210-n), and the scan switch 435 are turned on in the addressing process under the control of the controller unit 410, thereby selecting a display cell.

Thereafter, as illustrated in FIGS. 6b and 7, the first driving switch S1 of the first voltage applying unit 431 and a first switching element (one of switching elements 211-1 to 211-n) of the scan drivers 210-1 to 210-n are turned on in the sustain process under the control of the controller unit 410, thereby forming a first path □ of FIG. 6b. Here, as shown in FIG. 7, the potential difference Vy−Vz between the scan electrodes and the sustain electrodes becomes the first voltage that is the positive sustain voltage+Vs.

The second driving switch S2 of the first voltage applying unit 431 is turned on under the control of the controller unit 410, thereby forming a second path □ of FIG. 6b. As shown in FIG. 7, since the sustain electrodes are connected directly to the ground that is the reference potential node, the potential difference Vy−Vz between the scan electrodes and the sustain electrodes becomes the ground level.

The third driving switch S3 of the second voltage applying unit 433 and the second switching elements 213-1 to 213-n of the scan drivers 210-1 to 210-n are turned on under the control of the controller unit 410, thereby forming a third path □ of FIG. 6b. As depicted in FIG. 7, the potential difference Vy−Vz between the scan electrodes and the sustain electrodes becomes the second voltage that is the negative sustain voltage−Vs.

The fourth driving switch S4 of the second voltage applying unit 433 is turned on under the control of the controller unit 410, thereby forming a fourth path □ of FIG. 6b. Still referring to FIG. 7, since the sustain electrodes are connected directly to the ground that is the reference potential node, the potential difference Vy−Vz between the scan electrodes and the sustain electrodes becomes zero (0).

The waveform of the potential difference Vy−Vz between the scan electrodes and the sustain electrodes of FIG. 7 is identical to the waveform of the general sustain pulse by changes of the paths (□-□-□-□).

As described above, the electrode integration driving unit 430 alternately applies the first voltage+Vs and the second voltage−Vs to the scan electrodes Y1, Y2, . . . , Yn. Because the sustain electrodes Z1, Z2, . . . , Zn are connected to the ground that is the reference potential node, the sustain pulses are not applied to the sustain electrodes Z1, Z2, . . . , Zn differently from the conventional art. As a result, electromagnetic interferences and noises can be minimized.

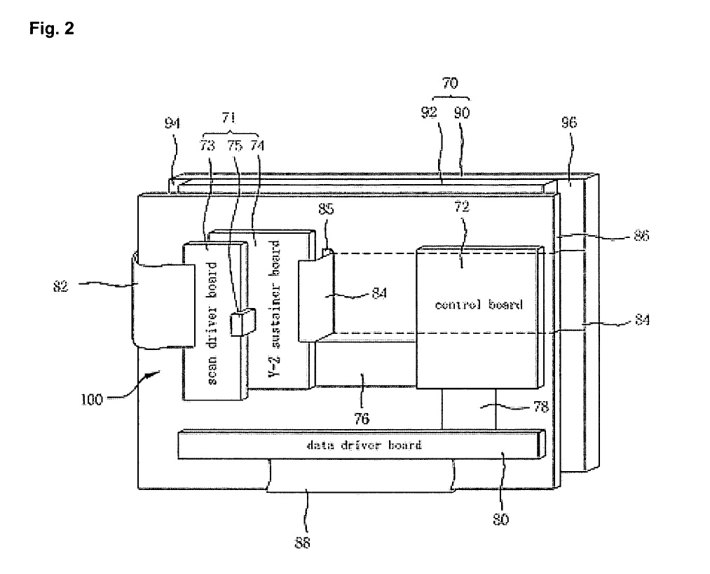

The conventional Y-Z sustainer board 74 of FIG. 2 is formed by integrating the circuit for driving the scan electrodes and the circuit for driving the sustain electrodes. However, the electrode integration driving unit 430 of the present invention only includes the circuit for driving the scan electrodes. Accordingly, the circuit structure of the electrode integration driving unit 430 is simplified to minimize heat generation on a PCB.

In addition, in the plasma display apparatus of the present invention, the sustain electrodes Z1, Z2, . . . , Zn are connected to the ground that is the reference potential node, for preventing voltage drop by impedance effects of the conductive wire or conductive material as in the Z FPC 84 of FIG. 2, thereby minimizing luminance differences at the right and left sides of the screen.

### EMBODIMENT 2

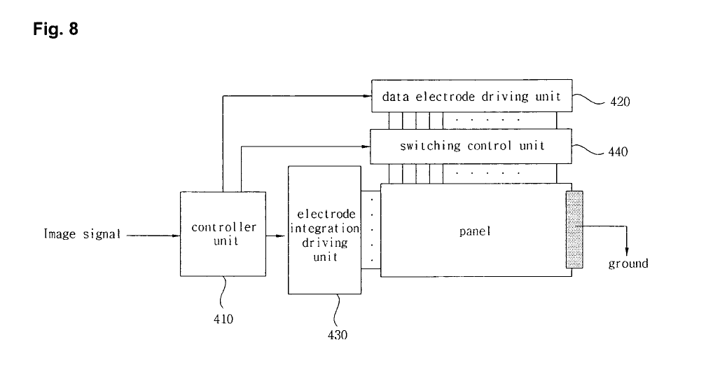

FIG. 8 illustrates a plasma display apparatus in accordance with a second embodiment of the present invention. Referring to FIG. 8, a driving device of a plasma display panel includes a plasma display panel 400, a controller unit 410, a data electrode driving unit 420, an electrode integration driving unit 430 and a switching control unit 440. Here, the operations of the plasma display panel 400, the controller unit 410, the data electrode driving unit 420 and the electrode integration driving unit 430 are identical to those of the first embodiment, and thus detailed explanations thereof are omitted.

<Switching Control Unit>

When the electrode integration driving unit 430 alternately applies a first voltage and a second voltage to scan electrodes in a sustain process, the switching control unit 440 floats data electrodes according to a switching control signal from the controller unit 410. Here, the switching control unit 440 includes a floating switch turned off by the switching control signal. The structure and operation of the switching control unit 440 including the floating switch will later be described in detail.

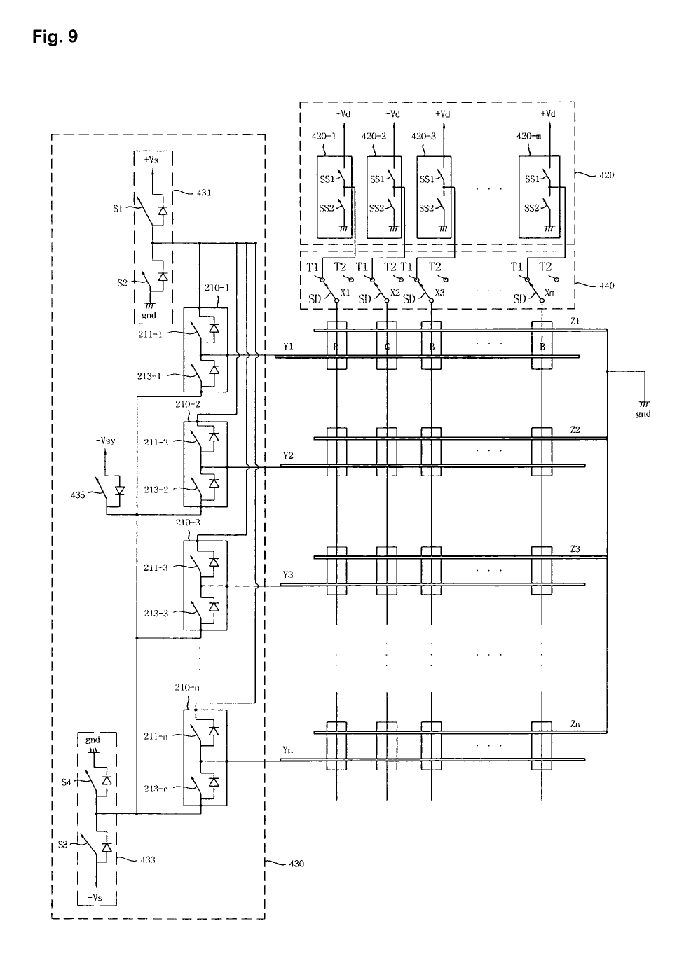

FIG. 9 is a circuit diagram illustrating the plasma display apparatus in accordance with the second embodiment of the present invention. As illustrated in FIG. 9, the plasma display apparatus includes a data electrode driving unit 420 for driving data electrodes, an electrode integration driving unit 430 having scan drivers 210-1 to 210-n, a first voltage applying unit 431, a second voltage applying unit 433 and a scan switch 435, and a switching control unit 440 for floating the data electrodes. Here, sustain electrodes Z1, Z2, . . . , Zn are connected directly to a ground level reference potential node.

The operations of the electrode driving unit 420 and the electrode integration driving unit 430 are identical to those of the first embodiment of FIG. 5, and thus detailed explanations thereof are omitted.

The switching control unit 440 includes a floating switch SD for connecting the data electrode driving unit 420 to the data electrodes X1, X2, . . . , Xm in an addressing process, and disconnecting the data electrode driving unit 420 from the data electrodes X1, X2, . . . , Xm in a sustain process.

That is, a first status switch SS1 or a second status switch SS2 of the data electrode driving unit 420 is turned on, for applying a high level or low level data voltage to the data electrodes X1 to Xm, thereby performing the addressing operation.

In the addressing process, the floating switch SD of the switching control unit 440 is switched to a terminal T1, for connecting the data electrode driving unit 420 to the data electrodes X1, X2, . . . , Xm. Accordingly, the data voltage applied by the data electrode driving unit 420 is transmitted to the data electrodes X1, X2, . . . , Xm.

In addition, in the sustain process, when the first voltage applying unit 431 and the second voltage applying unit 433 alternately apply a first voltage+Vs and a second voltage−Vs to scan electrodes Y1, Y2, . . . , Yn, the floating switch SD of the switching control unit 440 is switched to a terminal T2, for disconnecting the data electrode driving unit 420 from the data electrodes X1, X2, . . . , Xm. Thus, the data electrodes X1, X2, . . . , Xm are floated.

Therefore, the switching control unit 440 prevents a displacement current generated in the sustain process from flowing into the data electrode driving unit 420, thereby minimizing detrimental effects of the displacement current.

The operation of the driving device of the plasma display panel in accordance with the present invention will now be described in detail with reference to the accompanying drawings.

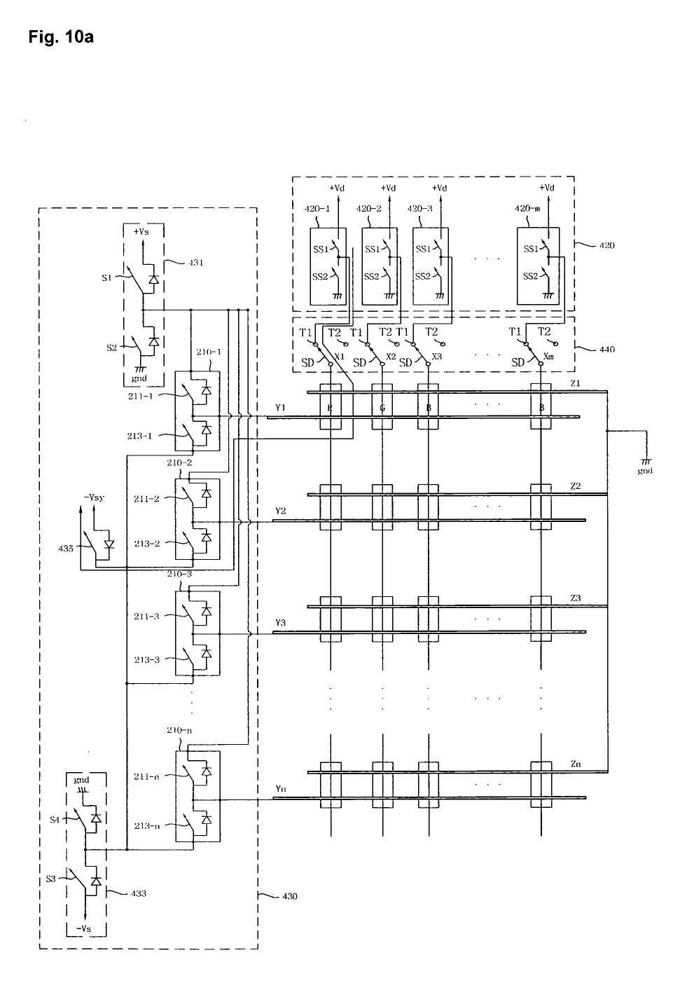

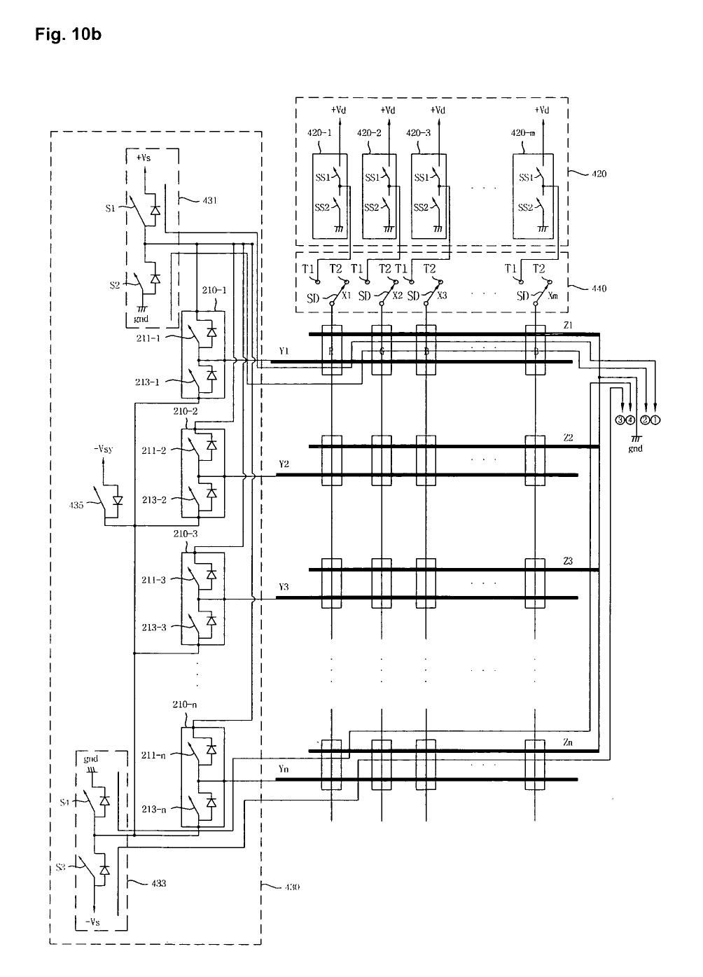

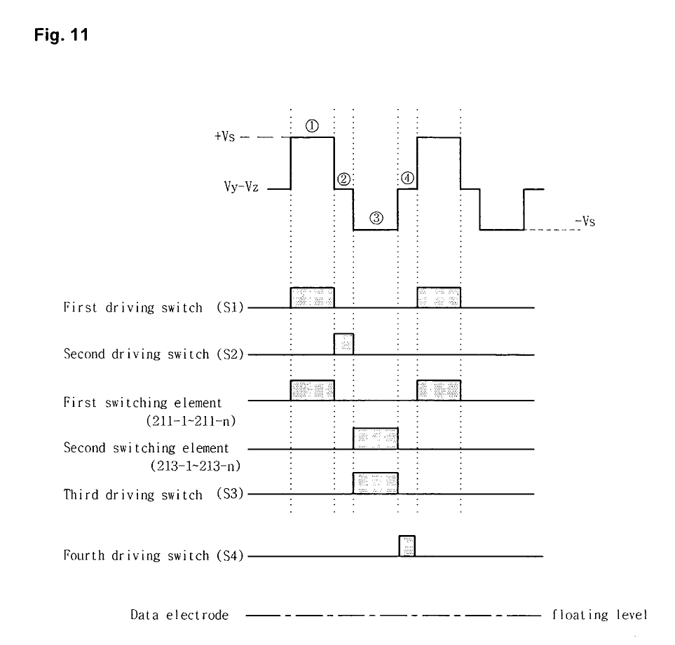

FIG. 10a illustrates a first operation of the plasma display apparatus in accordance with the second embodiment of the present invention. FIG. 10b illustrates a second operation of the driving device of the plasma display panel in accordance with the second embodiment of the present invention. FIG. 11 is a switching timing diagram for the operation of the second embodiment of the present invention.

As illustrated in FIG. 10a, one of the first status switch SS1 and the second status switch SS2 of the data electrode driving unit 420, the switching control unit 440, a second switching element (one of switching elements 213-1 to 213-n) of the selected scan driver (one of the scan drivers 210-1 to 210-n), and the scan switch 435 are turned on in the addressing process under the control of the controller unit 410, thereby performing the addressing process.

Here, the floating switch SD of the switching control unit 440 is switched to the terminal T1 under the control of the controller unit 410, thereby transmitting the data voltage to the data electrodes X1, X2, . . . , Xm.

Thereafter, as depicted in FIGS. 10b and 11, the first driving switch S1 and a first switching element (one of switching elements 211-1 to 211-n) are turned on in the sustain process under the control of the controller unit 410, thereby forming a first path □ of FIG. 10b. Here, as shown in FIG. 11, the potential difference Vy−Vz between the scan electrodes and the sustain electrodes becomes the first voltage that is the positive sustain voltage+Vs.

The second driving switch S2 is turned on under the control of the controller unit 410, thereby forming a second path □ of FIG. 10b. As shown in FIG. 11, the potential difference Vy−Vz between the scan electrodes and the sustain electrodes becomes the ground level.

The third driving switch S3 and the second switching elements 213-1 to 213-n are turned on under the control of the controller unit 410, thereby forming a third path □ of FIG. 10b. As depicted in FIG. 11, the potential difference Vy−Vz between the scan electrodes and the sustain electrodes becomes the second voltage that is the negative sustain voltage−Vs.

The fourth driving switch S4 is turned on under the control of the controller unit 410, thereby forming a fourth path □ of FIG. 10b. Still referring to FIG. 11, the potential difference Vy−Vz between the scan electrodes and the sustain electrodes becomes a ground level.

The waveform of the potential difference Vy−Vz between the scan electrodes and the sustain electrodes of FIG. 11 is identical to the waveform of the general sustain pulse by changes of the paths (□-□-□-□).

In the sustain process, the floating switch SD of the switching control unit 440 is switched to a terminal T2, for floating the data electrodes X1 to Xm, thereby preventing a displacement current generated in the sustain process from flowing into the data electrode driving unit 420.

As described above, the electrode integration driving unit 430 alternately applies the first voltage+Vs and the second voltage−Vs to the scan electrodes Y1, Y2, . . . , Yn. Because the sustain electrodes Z1, Z2, . . . , Zn are connected to the ground that is the reference potential node, the sustain pulses are not applied to the sustain electrodes Z1, Z2, . . . , Zn differently from the conventional art. As a result, electromagnetic interferences and noises can be minimized.

The conventional Y-Z sustainer board 74 of FIG. 2 is formed by integrating the circuit for driving the scan electrodes and the circuit for driving the sustain electrodes. However, the electrode integration driving unit 430 of the present invention only includes the circuit for driving the scan electrodes. Accordingly, the circuit structure of the electrode integration driving unit 430 is simplified to minimize heat generation on a PCB.

Furthermore, in the plasma display apparatus of the present invention, the sustain electrodes Z1, Z2, . . . , Zn are connected to the ground that is the reference potential node, for preventing voltage drop by impedance effects of the conductive wire or conductive material as in the Z FPC 84 of FIG. 2, thereby minimizing luminance differences at the right and left sides of the screen.

As a result, the driving device of the present invention prevents the data electrode driving unit 420 from being damaged or mistakenly operated due to the displacement current.

What is claimed is:

1. A plasma display apparatus, comprising:
a plasma display panel having scan electrodes and sustain electrodes connected to a reference potential node; and
an electrode integration driving unit for alternately applying a first voltage and a second voltage to the scan electrodes in a sustain period.

2. The plasma display apparatus according to claim 1, wherein the sustain electrodes are connected to the ground.

3. The plasma display apparatus according to claim 1, wherein the electrode integration driving unit alternately applies a first positive voltage and a second negative voltage to the scan electrodes.

4. The plasma display apparatus according to claim 3, wherein the electrode integration driving unit alternately applies the first positive voltage and the second negative voltage to the scan electrodes in the same amplitude.

5. The plasma display apparatus according to claim 1, further comprising a switching control unit for floating data electrodes in the sustain period.

6. The plasma display apparatus according to claim 5, wherein the electrode integration driving unit comprises a floating switch for applying signals corresponding to image data to the data electrodes in an addressing process, and floating the data electrodes in the sustain process.

7. The plasma display apparatus according to claim 1, wherein the electrode integration driving unit comprises:
(a) scan drivers connected to the scan electrodes, for applying the first voltage or the second voltage to the scan electrodes;
(b) a scan switch turned on in the addressing process, for applying a scan voltage to the scan electrode connected to the selected scan driver;
(c) a first voltage applying unit having a first driving switch for applying the first voltage to the scan electrodes through the scan drivers, and a second driving switch for applying the voltage of the reference potential node to the scan electrodes connected to the scan drivers; and
(d) a second voltage applying unit having a third driving switch for applying the second voltage to the scan electrodes connected to the scan drivers, and a fourth driving switch for applying the voltage of the reference potential node to the scan electrodes connected to the scan drivers.

8. The plasma display apparatus according to claim 7, wherein the first voltage applying unit comprises the first driving switch for applying the first voltage to the scan electrodes through the scan drivers, and the second driving switch for applying the ground level voltage to the scan electrodes connected to the scan drivers, and the second voltage applying unit comprises the third driving switch for applying the second voltage to the scan electrodes through the scan drivers, and the fourth driving switch for applying the ground level voltage to the scan electrodes connected to the scan drivers.

9. A plasma display apparatus, comprising:
a plasma display panel having scan electrodes and sustain electrodes connected to a reference potential;
an electrode integration driving unit for alternately applying a first positive voltage and a second negative voltage to the scan electrodes in a sustain period; and
a switching control unit for floating data electrodes in the sustain period.

10. The plasma display apparatus according to claim 9, wherein the sustain electrodes are connected to the ground.

11. The plasma display apparatus according to claim 9, wherein the electrode integration driving unit alternately applies a first positive voltage and a second negative voltage to the scan electrodes.

12. The plasma display apparatus according to claim 11, wherein the electrode integration driving unit alternately applies the first positive voltage and the second negative voltage to the scan electrodes in the same amplitude.

13. The plasma display apparatus according to claim 11, wherein the electrode integration driving unit comprises a floating switch for applying signals corresponding to image data to the data electrodes in an addressing process, and floating the data electrodes in a sustain process.

14. The plasma display apparatus according to claim 9, wherein the electrode integration driving unit comprises:
(a) scan drivers connected to the scan electrodes, for applying the first voltage or the second voltage to the scan electrodes;
(b) a scan switch turned on in the addressing process, for applying a scan voltage to the scan electrode connected to the selected scan driver;
(c) a first voltage applying unit having a first driving switch for applying the first voltage to the scan electrodes through the scan drivers, and a second driving switch for applying the voltage of the reference potential to the scan electrodes connected to the scan drivers; and
(d) a second voltage applying unit having a third driving switch for applying the second voltage to the scan electrodes connected to the scan drivers, and a fourth driving switch for applying the voltage of the reference potential to the scan electrodes connected to the scan drivers.

15. The plasma display apparatus according to claim 13, wherein the first voltage applying unit comprises the first driving switch for applying the first voltage to the scan electrodes through the scan drivers, and the second driving switch for applying the ground level voltage to the scan electrodes connected to the scan drivers, and the second voltage applying unit includes the third driving switch for applying the second voltage to the scan electrodes through the scan drivers, and the fourth driving switch for applying the ground level voltage to the scan electrodes connected to the scan drivers.

16. A driving method of a plasma display apparatus including scan electrodes and sustain electrodes connected to a reference potential node, comprising the steps of:
applying a first voltage to the scan electrodes in a sustain period; and
alternately applying the first voltage and a second voltage to the scan electrodes in the sustain period.

17. The driving method of the plasma display apparatus according to claim 16, wherein the sustain electrodes are connected to the ground.

18. The driving method of the plasma display apparatus according to claim 16, wherein the first voltage is a first positive voltage and the second voltage is a second negative voltage.

19. The driving method of the plasma display apparatus according to claim 18, wherein the first positive voltage is identical in amplitude to the second negative voltage.

20. The driving method of the plasma display apparatus according to claim 16, wherein, in the process for alternately applying the first voltage and the second voltage to the scan electrodes, data electrodes are floated.
